(19) United States
(12) Patent Application Publication
(10) Pub. No.: US 2025/0117449 A1
(43) Pub. Date: Apr. 10, 2025

(54) SYSTEMS AND METHODS FOR GENERATING A DIGITAL RIGHTS MANAGEMENT ("DRM")-PROTECTED INPUT FIELD

(71) Applicant: Capital One Services, LLC, McLean, VA (US)

(72) Inventors: Matthew HUNSBERGER, Hoboken, NJ (US); Shahalam BAIG, Rochester, NY (US); Jackson WESTWOOD, New York, NY (US); Shasanka BHANDARI, McLean, VA (US); Hyunwoo KANG, New York, NY (US)

(73) Assignee: Capital One Services, LLC, McLean, VA (US)

(21) Appl. No.: 18/905,190

(22) Filed: Oct. 3, 2024

Related U.S. Application Data
(60) Provisional application No. 63/587,891, filed on Oct. 4, 2023.
(60) Provisional application No. 63/665,485, filed on Jun. 28, 2024.
(60) Provisional application No. 63/683,063, filed on Aug. 14, 2024.

(51) Int. Cl. G06F 21/10; G06F 3/0482

(52) U.S. Cl. CPC G06F 21/101; G06F 3/0482

(57) ABSTRACT

Described are systems and methods for generating a digital rights management (“DRM”)-protected input field of a media content, including receiving, via a first graphical user interface (“GUI”), at least one user input associated with a DRM-protected input field, wherein the DRM-protected input field has been caused to be output via the GUI and is substantially hidden from view, based on the at least one user input, appending at least one DRM-protected media element to the DRM-protected input field via a browser module, and causing to output, via the first GUI, the DRM-protected input field with the appended DRM-protected media such that the appended DRM-protected media is substantially visible via the first GUI.

### CROSS-REFERENCE TO RELATED APPLICATION(S)

This application claims the benefit of pending U.S. Provisional Patent Application No. 63/587,891, filed on Oct. 4, 2023, pending U.S. Provisional Patent Application No. 63/665,485, filed on Jun. 28, 2024, and pending U.S. Provisional Patent Application No. 63/683,063, filed on Aug. 14, 2024, all of which are incorporated herein by reference in their entireties.

### TECHNICAL FIELD

Various embodiments of this disclosure relate generally to generating a digital rights management (“DRM”)-protected input field and, more particularly, to systems and methods for generating DRM-protected input field associated with a media content.

### BACKGROUND

Organizations such as banks and healthcare providers seek to protect sensitive or confidential information (e.g., personally identifiable information (“PII”), financial information, medical information, etc.) from social engineers. A social engineer is a person or entity who seeks to manipulate a target (e.g., a customer or employee of an organization) into divulging sensitive information that may be used for fraudulent purposes. That is, a social engineer is a person or entity who engages in social engineering. For example, when the target is a user who uses a display screen (also referred to herein as a “screen”) of a computing device to view an account number on a bank's website, a social engineer using another computing device may attempt to persuade the user to reveal the account number to the social engineer. More specifically, the social engineer may convince the user to (i) share the user's screen (displaying the account number) with the social engineer using a screen sharing or remote desktop application, or (ii) take a screenshot of the user's screen (displaying the account number) using a screenshotting application, and then transmit the screenshot to the social engineer.

To guard against such social engineering, the bank may employ digital rights management (“DRM”) technologies, which are technologies that limit the use of digital content. However, current DRM technologies may not be configured to protect users while sensitive information is actively being input to an input field.

This disclosure is directed to addressing one or more of the above-referenced challenges. The background description provided herein is for the purpose of generally presenting the context of the disclosure. Unless otherwise indicated herein, the materials described in this section are not prior art to the claims in this application and are not admitted to be prior art, or suggestions of the prior art, by inclusion in this section.

### SUMMARY OF THE DISCLOSURE

According to certain aspects of the disclosure, methods and systems are disclosed for generating a DRM-protected input field.

In one aspect, a method for generating a digital rights management (“DRM”)-protected input field of a media content. The method may include receiving, via a first graphical user interface (“GUI”), at least one user input associated with a DRM-protected input field, wherein the DRM-protected input field has been caused to be output via the GUI and is substantially hidden from view, based on the at least one user input, appending at least one DRM-protected media element to the DRM-protected input field via a browser module, and causing to output, via the first GUI, the DRM-protected input field with the appended DRM-protected media such that the appended DRM-protected media is substantially visible via the first GUI.

In another aspect, a system is disclosed. The system may include at least one memory storing instructions, and at least one processor operatively connected to the memory, and configured to execute the instructions to perform operations for generating a DRM-protected input field of a media content. The operations may include receiving, via a first graphical user interface (“GUI”), at least one user input associated with a DRM-protected input field, wherein the DRM-protected input field has been caused to be output via the GUI and is substantially hidden from view, based on the at least one user input, appending at least one DRM-protected media element to the DRM-protected input field via a browser module, and causing to output, via the first GUI, the DRM-protected input field with the appended DRM-protected media such that the appended DRM-protected media is substantially visible via the first GUI.

In another aspect, a method for generating a digital rights management (“DRM”)-protected input field of a media content is disclosed. The method may include determining, via a browser module, whether digital extraction is indicated, upon determining digital extraction is indicated, causing to output, via a first graphical user interface (“GUI”), a DRM-protected input field, the DRM-protected input field having been generated via an application server by: detecting an input element of an HTML associated with the media content, and replacing the input element in the HTML with a div element to generate the DRM-protected input field, wherein the DRM-protected input field is substantially hidden from view using Cascading Style Sheets (“CSS”), receiving, via the first GUI, at least one user input associated with the DRM-protected input field, based on the at least one user input, appending at least one DRM-protected media element to the DRM-protected input field via the browser module, wherein the at least one DRM-protected media element is retrieved from a cache in a Document Object Model (“DOM”) associated with the media content, and causing to output, via the first GUI, the DRM-protected input field with the appended DRM-protected media such that the appended DRM-protected media is substantially visible via the first GUI.

It is to be understood that both the foregoing general description and the following detailed description are exemplary and explanatory only and are not restrictive of the disclosed embodiments, as claimed.

### BRIEF DESCRIPTION OF THE DRAWINGS

The accompanying drawings, which are incorporated in and constitute a part of this specification, illustrate various exemplary embodiments and together with the description, serve to explain the principles of the disclosed embodiments.

FIG. 1 depicts an exemplary environment for generating a DRM-protected input field, according to one or more embodiments.

FIGS. 2A-2D depict an exemplary method for generating a DRM-protected input field, according to one or more embodiments.

FIGS. 3A-3B depict an exemplary schematic for generating a DRM-protected input field, according to one or more embodiments.

FIG. 4 depicts a simplified functional block diagram of a computer, according to one or more embodiments.

### DETAILED DESCRIPTION OF EMBODIMENTS

Reference to any particular activity is provided in this disclosure only for convenience and not intended to limit the disclosure. The disclosure may be understood with reference to the following description and the appended drawings, wherein like elements are referred to with the same reference numerals.

The terminology used below may be interpreted in its broadest reasonable manner, even though it is being used in conjunction with a detailed description of certain specific examples of the present disclosure. Indeed, certain terms may even be emphasized below; however, any terminology intended to be interpreted in any restricted manner will be overtly and specifically defined as such in this Detailed Description section. Both the foregoing general description and the following detailed description are exemplary and explanatory only and are not restrictive of the features, as claimed.

In this disclosure, the term “based on” means “based at least in part on.” The singular forms “a,” “an,” and “the” include plural referents unless the context dictates otherwise. The term “exemplary” is used in the sense of “example” rather than “ideal.” The terms “comprises,” “comprising,” “includes,” “including,” or other variations thereof, are intended to cover a non-exclusive inclusion such that a process, method, or product that comprises a list of elements does not necessarily include only those elements, but may include other elements not expressly listed or inherent to such a process, method, article, or apparatus. The term “or” is used disjunctively, such that “at least one of A or B” includes, (A), (B), (A and A), (A and B), etc. Relative terms, such as, “substantially,” “approximately,” “about,” and “generally,” are used to indicate a possible variation of ±10% of a stated or understood value.

It will also be understood that, although the terms first, second, third, etc. are, in some instances, used herein to describe various elements, these elements should not be limited by these terms. These terms are only used to distinguish one element from another. For example, a first contact could be termed a second contact, and, similarly, a second contact could be termed a first contact, without departing from the scope of the various described embodiments. The first contact and the second contact are both contacts, but they are not the same contact.

As used herein, the term “if” is, optionally, construed to mean “when” or “upon” or “in response to determining” or “in response to detecting,” depending on the context. Similarly, the phrase “if it is determined” or “if [a stated condition or event] is detected” is, optionally, construed to mean “upon determining” or “in response to determining” or “upon detecting [the stated condition or event]” or “in response to detecting [the stated condition or event],” depending on the context.

The term “user” or the like may refer to a person authorized to access an account, attempting to access an account, etc. As used herein, the term “social engineer” may be a person or entity who seeks to manipulate a target (e.g., a customer or employee of an organization) into divulging sensitive information that may be used for fraudulent purposes. That is, a social engineer is a person or entity who engages in social engineering.

As used herein, the phrase “media content” may represent a browser, a website, a webpage, etc. As used herein, the phrase “content element” may represent text data (e.g., letters, numbers, symbols, metadata, or alt text), image data (e.g., an image, a graphic, a sequence of image frames, or a video), audio data (e.g., a sequence of audio frames), or video data (e.g., a sequence of image frames). Further, a content element may represent data included in, or referred by, an HTML element of an HTML page corresponding to (or representing) the webpage. For example, a content element may be included in HTML used to structure the website, such as a Document Object Model (“DOM”), Cascading Style Sheets (“CSS”), etc. In some aspects, the content element may include or represent sensitive or confidential information (e.g., that may be displayed on a webpage (or webpage(s), website(s), portal(s) or application(s), etc.).

As used herein, the phrase “sensitive information” or “sensitive data” may refer to data that is intended for, or restricted to the use of, one or more users or entities (e.g., a user 105, an organization associated with a DRM-protection system 131, etc.). Moreover, sensitive data may represent data that is personal, private, confidential, privileged, secret, classified, or in need of protection, for example. Sensitive information may include personally identifiable information (“PII”) (e.g., a name, an address, a phone number, a social security number, etc.), financial information (e.g., an account number, an account balance, debits, credits, etc.), medical information (e.g., test results, appointments, medications, etc.), business information (e.g., proprietary information, trade secrets, etc.), government information (e.g., classified or secret information), any information a user may wish to not be shared with a third party, etc.

The phrase “hypertext markup language,” “HTML,” or the like may refer to a standardized system for tagging text files to achieve font, color, graphic, or hyperlink effects on World Wide Web pages. The phrase “HTML element” may represent a component of an HTML page, and may include, for example, a start tag and end tag, and as noted above, a content element or a reference to a content element (e.g., link, hyperlink, address, or path to a content element). Further, in some embodiments, an HTML element may include one or more HTML elements (e.g., nested HTML elements). As used herein, the term “pixel” may refer to the smallest element (or unit) of a display screen that can be programmed by (or manipulated through) software. In some embodiments, a pixel may include sub-pixels (e.g., a red sub-pixel, a green sub-pixel, and a blue sub-pixel) that emit light to create a color displayed on the display screen. In some aspects, the color may be included in, or represent, text data, image data, or video data presented on the display screen.

As used herein, the phrase “digital extraction” may refer to any process of copying content (e.g., audio, video, text, image, etc.), such as ripping, screensharing, screenshotting, etc. As used herein, the term “screenshare” or “screen share” may refer to a real time or near real time electronic transmission of data displayed on a display screen of a user's computing device to one or more other computing devices. The term “screensharing” or “screen sharing” and the phrase “being screenshared” or “being screen shared” may refer to performing a screenshare. In some aspects, screensharing may be performed using a screensharing application (e.g., a video or web conferencing application such as Zoom®, Microsoft's Teams®, or the like, or a remote desktop application such as Microsoft Remote Desktop, Chrome Remote Desktop, or the like). As used herein, the term “screenshot” or “screen shot” may represent an image of data displayed on a display screen of a computing device, where the image may be captured or recorded. The term “screenshotting” or “screen shotting” and the phrase “being screenshotted” or “being screen shotted” may refer to capturing or recording a screenshot. In some aspects, screenshotting may be performed using a screenshotting application (e.g., the Snipping Tool in Microsoft Windows 11® or an application accessed using a Print Screen key of a keyboard or keypad).

In an exemplary use case, a user may wish to protect sensitive information from digital extraction. In some embodiments, a website, a webpage, an application, etc. may be configured to output a DRM-protected input field. For example, if a user is asked to input their social security number on a webpage, the DRM-protected input field may be output such that they are overlaid on the input field for the social security number. Based on the user input obtained via the DRM-protected input field, at least one character video may be appended to the DRM-protected input field. For example, one character video may be appended for each keystroke. The user input may be transmitted to an analysis system. The analysis system may generate an alert based on the user input. The alert may be output to a graphical user interface (“GUI”) associated with the analysis system, such as a third-party security system

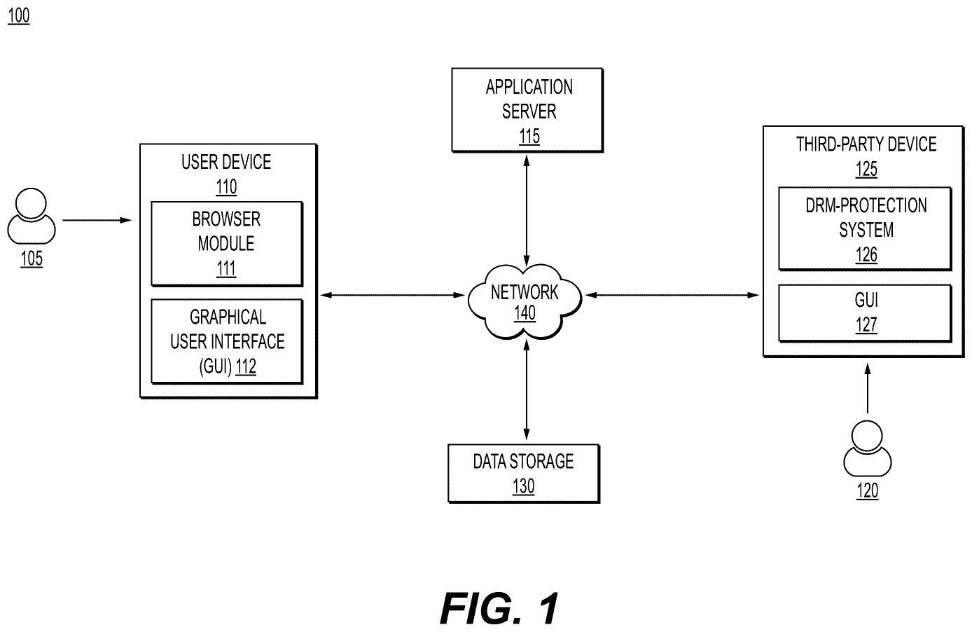

FIG. 1 depicts an example environment 100 that may be utilized with techniques presented herein. In some aspects, the environment 100 may be an embodiment of (i) environment 100 described in U.S. Provisional Application 63/587,891, filed on Oct. 4, 2023, (ii) environment 100 described in U.S. Provisional Application 63/665,485, filed on Jun. 28, 2024, or (iii) environment 100 described in U.S. Provisional Patent Application No. 63/683,063, filed Aug. 14, 2024 where each of these U.S. provisional applications is incorporated by reference herein in its entirety. FIG. 1 depicts an exemplary environment 100 for generating a digital rights management (“DRM”)-protected input field, according to one or more embodiments. Environment 100 may include one or more aspects that may communicate with each other over a network 140, including, e.g., at least one memory storing instructions, and at least one processor operatively connected to the at least one memory and configured to execute the instructions to perform operations for generating a DRM-protected media input field.

In some embodiments, a user 105 may interact with a user device 110 such that media content (e.g., a browser, a website, a webpage, etc.) including at least one input element may be loaded. As depicted in FIG. 1, a user 105 may be an individual authorized to use, access, etc. user device 110 or access, view, etc. sensitive information, for example, by providing a correct input to an input element or DRM-protected input element. User device 110 may interact with at least one of an application server 115, a third-party device 125, a data storage 130, etc. User device 110 may be configured to enable user 105 to access or interact with other systems in environment 100.

In some embodiments, a third-party user 120 may interact with a third-party device 125 such that information associated with at least one user input may be managed. A user 120 may be an individual associated with a third party, such as a third party facilitating, monitoring, etc. the DRM protections discussed herein. Third-party device 125 may be configured to enable third-party user 120 to access or interact with other systems in environment 100.

In some embodiments, user device 110 or third-party device 125 may be a computer system, e.g., a desktop computer, a laptop computer, a tablet, a smart cellular phone, a smart watch or other electronic wearable, etc. In some embodiments, user device 110 or third-party device 125 may include one or more electronic applications, e.g., a program, plugin, browser extension, etc., installed on a memory of user device 110 or third-party device 125. In some embodiments, the electronic applications may be associated with one or more of the other components in the environment 100.

User device 110 may include a browser module 111 or a graphical user interface (“GUI”) 112. User device 110—or the one or more aspects of user device 110, e.g., browser module 111, GUI 112, etc.—may be configured to obtain data from one or more aspects of environment 100. For example, user device 110 may be configured to receive data from browser module 111, GUI 112 (e.g., via one or more inputs from user 105), application server 115, third-party device 125, DRM-protection system 126, GUI 127 (e.g., via one or more inputs from third-party user 120), data storage 130, etc. User device 110 may be configured to transmit data to one or more aspects of environment 100, e.g., to browser module 111, GUI 112, application server 115, third-party device 125, DRM-protection system 126, GUI 127, data storage 130, etc.

Browser module 111 may be configured to determine whether digital extraction is indicated. In some embodiments, browser module 111 may be configured to detect, analyze, or transmit (e.g., to application server 115) an indication of digital extraction (e.g., screensharing, screenshotting, screen capture, etc.). In some embodiments, browser module 111 may be configured to receive the indication of digital extraction from other aspects of environment 100, such as user device 110, application server 115, data storage 130, etc. In some embodiments, browser module 111 may be configured to detect digital extraction based on indirect measures of digital extraction. For example, browser module 111 may be configured to detect user input(s) that may be indicative of screenshotting, such as simultaneously pressing and releasing the lock button and the volume up button on a social engineer's user device. In some embodiments, browser module 111 may be configured to infer or predict digital extraction may be occurring. For example, browser module 111 may be configured to determine a screensharing application, such as Zoom®, may be operating on a user device (e.g., user device 110) while a user (e.g., user 105) is providing at least one user input (e.g., via GUI 112). Browser module 111 may be configured to determine the indication of digital extraction based on the simultaneous operation of the screensharing application and the accessing sensitive information on user device 110.

Browser module 111 may be configured to obtain data from one or more aspects of environment 100. For example, browser module 111 may be configured to receive data from user device 110, GUI 112 (e.g., via one or more inputs from user 105), application server 115, third-party device 125, DRM-protection system 126, GUI 127 (e.g., via one or more inputs from third-party user 120), data storage 130, etc. Browser module 111 may be configured to transmit data to one or more aspects of environment 100. For example, browser module 111 may be configured to transmit data to user device 110, GUI 112, application server 115, third-party device 125, DRM-protection system 126, GUI 127, data storage 130, etc.

GUI 112 may be configured to receive at least one user input. The at least one user input may include a keystroke (e.g., a keyboard input, a digital pencil input, etc.), an indication (e.g., via a computer mouse, a user's finger, etc.), etc.

GUI 112 may be configured to cause to output at least one alert (e.g., a first alert, a second alert, a third alert, etc.), etc. GUI 112 may be configured to receive the at least one alert from other aspects of environment 100, such as application server 115, third-party device 125, DRM-protection system 126, etc.

GUI 112 may be configured to obtain data from one or more aspects of environment 100. For example, GUI 112 may be configured to receive data from user device 110, browser module 111, application server 115, third-party device 125, DRM-protection system 126, GUI 127 (e.g., via one or more inputs from third-party user 120), data storage 130, etc. GUI 112 may be configured to transmit data to one or more aspects of environment 100. For example, GUI 112 may be configured to transmit data to user device 110, browser module 111, application server 115, third-party device 125, DRM-protection system 126, GUI 127, data storage 130, etc.

Application server 115 may be configured to generate a DRM-protected input field. The DRM-protected input field may include a div element. The div element may be an element that groups similar sets of content together on a webpage. Utilization of a div element in the DRM-protected input field may enable application server 115 to track user inputs.

In some embodiments, application server 115 may be configured to generate the DRM-protected input field by replacing a detected input element of the HTML with a div element. Application server 115 may be configured to detect an input element of an HTML associated with the media content. For example, application server 115 may be configured to scan the HTML associated with a webpage to find at least one input element. Application server 115 may be configured to replace the detected input element of the HTML with a div element, thereby generating a DRM-protected input field.

Application server 115 may be configured to generate the DRM-protected input field such that the DRM-protected input field is substantially hidden from view using Cascading Style Sheets (“CSS”). For example, application server 115 may be configured to generate the DRM-protected input field such that, when the DRM-protected input field is output via a GUI (e.g., GUI 112), the user interacting with the GUI (e.g., user 105 interacting with GUI 112) may not be able to distinguish the DRM-protected input field from the input element.

Application server 115 may be configured to generate at least one DRM-protected media element. A DRM-protected media element may be a single frame-looped video. The DRM-protected media element may include a representation of a user input, as discussed in further detail below.

In some embodiments, application server 115 may be configured to generate the at least one DRM-protected media element based on possible user inputs to the DRM-protected input field. The possible user inputs may include possible keystrokes. The possible keystrokes may be customized based on an alphabet (e.g., alphabets of various languages), numbers (e.g., Arabic numerals, Roman numerals, etc.), symbols (e.g., ampersand, asterisk, percent, exclamation point, en dash, em dash, carrot, parentheses, etc.), etc.

Application server 115 may be configured to generate the DRM-protected media element to include a representation of a user input. For example, where the user input is the keystroke “A,” application server 115 may be configured to generate the DRM-protected media element to include a single frame-looped video of the letter “A.”

In some embodiments, application server 115 may be configured to associate a given DRM-protected media element with a given user input. The association may be based on the DRM-protected media element matching the user input, a representation of the DRM-protected media element, or it may be random. For example, where the user input is the keystroke “3,” application server 115 may be configured to generate the DRM-protected media to include a single frame-looped video of the number “3.” In another example, where the user input is the keystroke “3,” application server 115 may be configured to generate the DRM-protected media to include a single frame-looped video of the symbol “&.” In a further example, where the at least one user input includes a first keystroke “3” and a second keystroke “3,” application server 115 may be configured to generate at least one DRM-protected media to include a single frame-looped video of the symbol “&” for the first keystroke and a single frame-looped video of the letter “Q” for the second keystroke.

Application server 115 may be configured to determine user input data. In some embodiments, application server 115 may be configured to track the at least one user input (e.g., the order, the content, etc.) via JavaScript® to determine user input data. For example, where the keystrokes are “1,” “2,” “backspace,” and “3,” application server 115 may be configured to determine the user input data includes keystroke content of “1” and “3” (e.g., the keystroke “backspace” may indicate that the keystroke “2” was erroneous) and a keystroke order of “1” then “3” (e.g., not “3” then “1”).

In another example, application server 115 may be configured to determine the user input data includes at least one of (i) an order of the retrieved at least one DRM-protected media element or (ii) an order of the at least one user input. As discussed in more detail below, the at least one determined (i) order of the retrieved at least one DRM-protected media element or (ii) order of the at least one user input may be utilized by an analysis system (e.g., DRM-protection system 126) in analyzing the user input.

Application server 115 may be configured to cache the at least one DRM-protected media element in a Document Object Model (“DOM”) associated with the media content. Application server 115 may be configured to cache each of the at least one DRM-protected media element based on an associated user input. Further, where the at least one DRM-protected media element is cached in the DOM, application server 115 may be configured to retrieve the at least one DRM-protected media element from the DOM (e.g., based on the user input). For example, application server 115 may be configured to cache a DRM-protected media element representing the letter “K” such that when a user (e.g., user 105) inputs the keystroke “K,” the DRM-protected media element representing the letter “K” may be retrieved.

In some embodiments, application server 115 may be configured to cache the at least one DRM-protected media element with the user input data. For example, application server 115 may be configured to cache a DRM-protected media element representing the letter “F” with user input data that this DRM-protected media element is associated with the keystroke “F.”

In some embodiments, application server 115 may be configured to convert a retrieved DRM-protected media element to a text element based on what the DRM-protected media element may represent. For example, where the DRM-protected media is representative of the number “3,” application server 115 may be configured to convert the DRM-protected media to the text element “3.”

Application server 115 may be configured to append at least one DRM-protected media element to a DRM-protected input field. In some embodiments, application server 115 may be configured to append the at least one DRM-protected media element based on one or both of the at least one user input (e.g., at least one keystroke) or the user input data. For example, where the user input data includes the keystrokes “A,” “B,” and “C” in that order, application server 115 may be configured to append to the DRM-protected input field the DRM-protected media element representative of the keystroke “A,” then the DRM-protected media element representative of the keystroke “B,” then the DRM-protected media element representative of the keystroke “C,” in the order. It should be noted that in some embodiments, browser module 111 may be configured to append the at least one DRM-protected media element to the DRM-protected input field, as discussed herein. For example, browser module 111 may be configured to append the at least one DRM-protected media element to the DRM-protected input field using JavaScript®.

Application server 115 may be configured to obtain data from one or more aspects of environment 100. For example, application server 115 may be configured to receive data from user device 110, browser module 111, GUI 112 (e.g., via one or more inputs from user 105), third-party device 125, DRM-protection system 126, GUI 127 (e.g., via one or more inputs from third-party user 120), data storage 130, etc. Application server 115 may be configured to transmit data to one or more aspects of environment 100. For example, application server 115 may be configured to transmit data to user device 110, browser module 111, GUI 112, third-party device 125, DRM-protection system 126, GUI 127, data storage 130, etc.

Third-party device 125 may be configured to enable user 120 to access or interact with other systems in the environment 100. Third-party device 125 may include a digital rights management (“DRM”)-protection system 126 (e.g., an analysis system) or a GUI 127. Third-party device 125—or the one or more aspects of third-party device 125, e.g., DRM-protection system 126, GUI 127, etc.—may be configured to obtain data from one or more aspects of environment 100. For example, third-party device 125 may be configured to receive data from user device 110, browser module 111, GUI 112 (e.g., via one or more inputs from user 105), application server 115, DRM-protection system 126, GUI 127 (e.g., via one or more inputs from user 120), data storage 130, etc. Third-party device 125 may be configured to transmit data to one or more aspects of environment 100, e.g., to user device 110, browser module 111, GUI 112 (e.g., via one or more inputs from user 105), application server 115, DRM-protection system 126, GUI 127 (e.g., via one or more inputs from user 120), data storage 130, etc.

DRM-protection system 126 may be an analysis system configured to determine whether the at least one user input matches an expected input value. The expected input value may be the at least one user input or user input data that may be expected for a given DRM-protected input field. For example, if the expected input value is “A” then “3,” a user input of “3” then “A” may be determined not to match. In another example, if the expected input value is “A” then “3,” a user input of “A” then “3” may be determined to match.

In another example, DRM-protection system 126 may be configured to determine whether at least one of the determined (i) order of the retrieved at least one DRM-protected media element or (ii) order of the at least one user input matches the expected input value. As discussed above, application server 115 may be configured to determine at least one of (i) the order of the retrieved at least one DRM-protected media element or (ii) the order of the at least one user input, which application server 115 may be configured to transmit to DRM-protection system 126.

DRM-protection system 126 may be configured to implement at least one protective measure. The at least one protective measure may be configured to protect (or safeguard) a content element, sensitive information, etc. The at least one protective measure may include at least one of pausing, locking, canceling, etc. an account (e.g., a financial account) associated with the sensitive information, pausing a current financial transaction, pausing subsequent financial transactions, transmitting the at least one alert (e.g., to GUI 112), etc. In some embodiments, DRM-protection system 126 may be configured to implement the at least one protective measure based on at least one of the indication of digital extraction, the at least one alert (e.g., the first alert, the second alert, the third alert, etc.), a determination that an expected input value is not matched, etc. For example, if the user input does not match the expected input value, DRM-protection system 126 may be configured to lock (or freeze) a checking account associated with the checking account number as a precautionary measure. In another example, upon determining at least one of (i) the order of the retrieved at least one DRM-protected media element or (ii) the order of the at least one user input does not match the expected input value, DRM-protection system 126 may be configured to initiate at least one protective measure.

DRM-protection system 126 may be configured to generate the at least one alert (e.g., the first alert, the second alert, the third alert, etc.) based on at least one user input (e.g., a first user input, a second user input, etc.), the user input data, the determination that the expected input value is not matched, etc. For example, DRM-protection system 126 may be configured to generate the at least one alert upon determining the at least one user input does not match the expected input value.

In some embodiments, DRM-protection system 126 may be configured to generate at least one alert (e.g., a first alert, a second alert, a third alert, etc.) based on an intended recipient. A first alert may be generated based on the user (e.g., user 105) being the intended recipient. For example, the first alert may be generated to include a natural language message for user 105 (e.g., “Your data may be at risk,” “Your information may be exposed,” etc.). A second alert may be generated based on the third-party user (e.g., user 120) being the intended recipient. For example, the second alert may be generated to include a natural language message for user 120 (e.g., “User A's data may be compromised,” etc.).

DRM-protection system 126 maybe configured to obtain data from one or more aspects of environment 100. For example, DRM-protection system 126 may be configured to receive data from user device 110, browser module 111, GUI 112 (e.g., via one or more inputs from user 105), application server 115, third-party device 125, GUI 127 (e.g., via one or more inputs from user 120), data storage 130, etc. DRM-protection system 126 may be configured to transmit data to one or more aspects of environment 100, e.g., to user device 110, browser module 111, GUI 112, application server 115, third-party device 125, GUI 127, data storage 130, etc.

GUI 127 may be configured to output the at least one alert (e.g., the first alert, the second alert, the third alert, etc.). For example, GUI 127 may be configured to output the second alert. User 120 may interact with the second alert via GUI 127. GUI 127 may be configured to output the at least two layered security elements (e.g., with the first layer visible, with the second layer visible, with the third layer visible, etc.).

GUI 127 maybe configured to obtain data from one or more aspects of environment 100. For example, GUI 127 may be configured to receive data from user device 110, browser module 111, GUI 112 (e.g., via one or more inputs from user 105), application server 115, third-party device 125, DRM-protection system 126, data storage 130, etc. GUI 127 may be configured to transmit data to one or more aspects of environment 100, e.g., to user device 110, browser module 111, GUI 112, application server 115, third-party device 125, DRM-protection system 126, data storage 130, etc.

Data storage 130 may be configured to cache the DRM-protected input field, the at least one DRM-protected media element, the at least one user input (e.g., the first user input, the second user input, etc.), the user input data, etc. Data storage 130 may be configured to receive data from other aspects of environment 100, such as from user device 110, browser module 111, GUI 112 (e.g., via one or more inputs from user 105), application server 115, third-party device 125, DRM-protection system 126, GUI 127 (e.g., via one or more inputs from user 120), etc. Data storage 130 may be configured to transmit data to other aspects of environment 100, such as to user device 110, browser module 111, GUI 112, application server 115, third-party device 125, DRM-protection system 126, GUI 127, etc.

One or more of the components in FIG. 1 may communicate with each other or other systems, e.g., across network 140. In some embodiments, network 140 may connect one or more components of environment 100 via a wired connection, e.g., a USB connection between user device 110 and data storage 130. In some embodiments, network 140 may connect one or more aspects of environment 100 via an electronic network connection, for example a wide area network (WAN), a local area network (LAN), personal area network (PAN), a content delivery network (CDN), or the like. In some embodiments, the electronic network connection includes the internet, and information and data provided between various systems occurs online. “Online” may mean connecting to or accessing source data or information from a location remote from other devices or networks coupled to the Internet. Alternatively, “online” may refer to connecting or accessing an electronic network (wired or wireless) via a mobile communications network or device. The Internet is a worldwide system of computer networks—a network of networks in which a party at one computer or other device connected to the network may obtain information from any other computer and communicate with parties of other computers or devices. The most widely used part of the Internet is the World Wide Web (often-abbreviated “WWW” or called “the Web”). A “website page,” a “portal,” or the like generally encompasses a location, data store, or the like that is, for example, hosted or operated by a computer system so as to be accessible online, and that may include data configured to cause a program such as a web browser to perform operations such as send, receive, or process data, generate a visual display or an interactive interface, or the like. In any case, the connections within the environment 100 may be network, wired, any other suitable connection, or any combination thereof.

Although depicted as separate components in FIG. 1, it should be understood that a component or portion of a component in the environment 100 may, in some embodiments, be integrated with or incorporated into one or more other components. For example, application server 115 may be integrated in browser module 111. In some embodiments, operations or aspects of one or more of the components discussed above may be distributed amongst one or more other components, e.g., one or both of browser module 111 or application server 115.

In some embodiments, some of the components of environment 100 may be associated with a common entity, while others may be associated with a disparate entity. For example, browser module 111 and application server 115 may be associated with a common entity (e.g., an entity with which user 105 has an account) while data storage 130 may be associated with a third party (e.g., a provider of data storage services). Any suitable arrangement or integration of the various systems and devices of the environment 100 may be used.

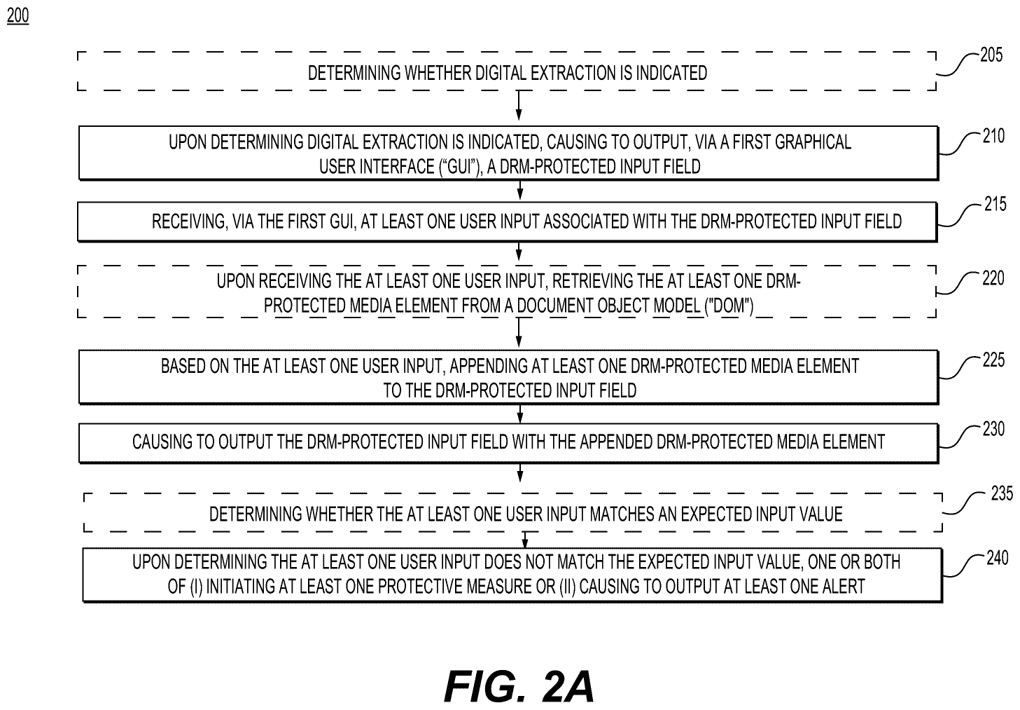

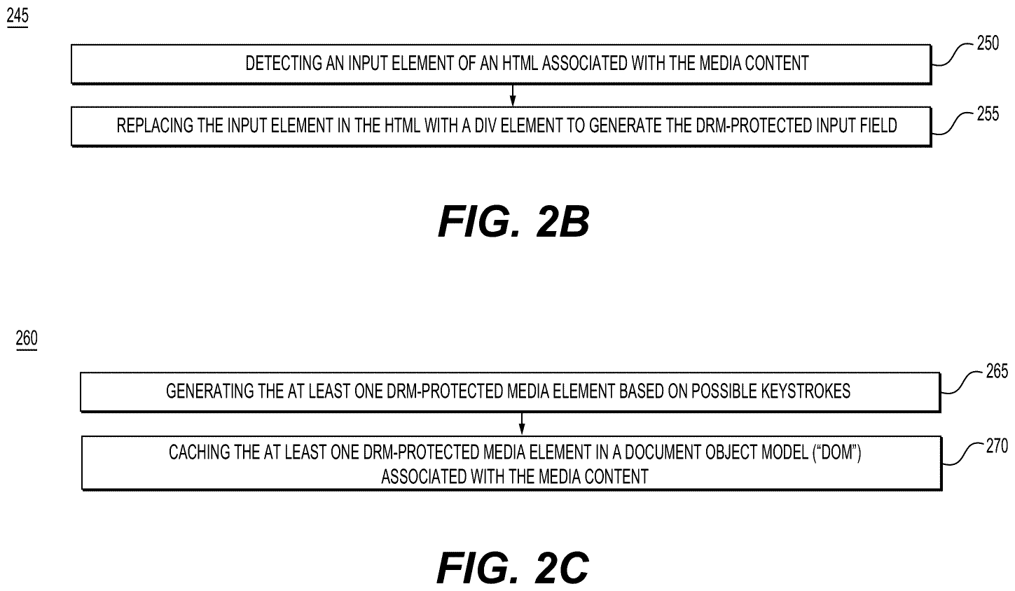

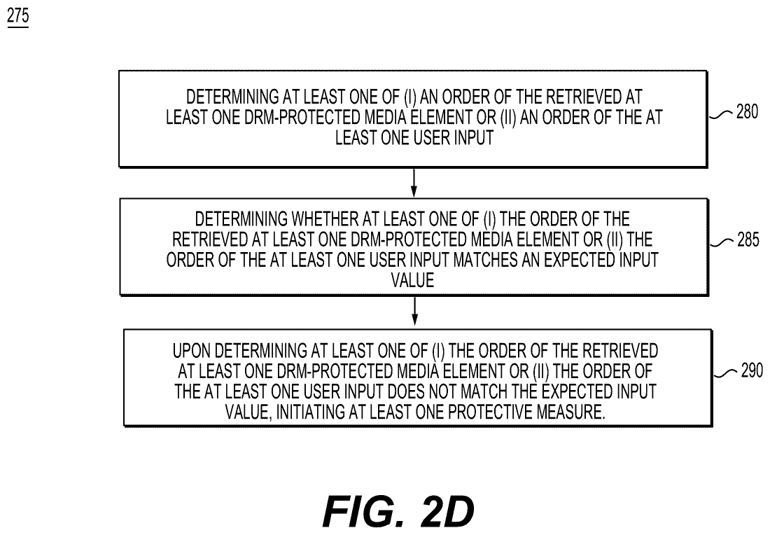

FIGS. 2A-2D depict an exemplary method for generating a DRM-protected input field of a media content (e.g., a webpage), according to one or more embodiments. As depicted in method 200 of FIG. 2A, optionally at step 205, it may be determined (e.g., via browser module 111) whether digital extraction is indicated. In some embodiments, the indication of digital extraction may be determined based on at least one indirect factor, such as user inputs, enabled settings, concurrently operating applications, etc. For example, if a user input that may be indicative of screenshotting is detected, such as Zoom® operating on a user device (e.g., on user device 110) while a user (e.g., user 105) is accessing sensitive information, digital extraction may be indicated.

In some embodiments, a trained machine learning model may be configured to determine whether digital extraction is indicated. For example, the trained machine learning model may predict whether digital extraction is indicated based on the indication of sensitive information, the at least one indirect factor, the user input (e.g., the first user input, the second user input, etc.), etc.

At step 210, a DRM-protected input field may be caused to be output (e.g., via GUI 112). In some embodiments, the DRM-protected input field may be caused to be output in response to the determination that digital extraction is indicated. As discussed below, the DRM-protected input field may be generated (e.g., via method 245), and the generated DRM-protected input field may be transmitted (e.g., via application server 115) to a GUI (e.g., GUI 112). The GUI (e.g., GUI 112) may cause to output the generated DRM-protected input field.

In some embodiments, the DRM-protected input field to be caused to be output may be generated (e.g., via application server 115). As depicted in method 245 of FIG. 2B, at step 250, an input element of an HTML associated with the media content may be detected (e.g., via application server 115). At step 255, the detected input element in the HTML may be replaced with a div element to generate the DRM-protected input field. The DRM-protected input field may be generated to be substantially hidden from view using Cascading Style Sheets (“CSS”). For example, the DRM-protected input field may be generated such that, when the DRM-protected input field is output via a GUI (e.g., GUI 112), the user interacting with the GUI (e.g., user 105 interacting with GUI 112) may not be able to detect that the DRM-protected input field differs from the input element.

Returning to FIG. 2A, at step 215, at least one user input associated with the DRM-protected input field may be received (e.g., via GUI 112). As discussed herein, the at least one user input may include at least one keystroke (e.g., a keyboard input, etc.), an indication (e.g., via a computer mouse, etc.), etc. In some embodiments, user input data may be collected (e.g., via JavaScript®) when the at least one user input associated with the DRM-protected input field is received (e.g., via GUI 112). For example, where the at least one user input includes the keystrokes “1,” “2,” “backspace,” and “3,” user input data associated with the at least one user input may be determined to include keystroke content of “1” and “3” (e.g., the keystroke “backspace” may indicate that the keystroke “2” was erroneous) and a keystroke order of “1” then “3” (e.g., not “3” then “1”). In some embodiments, the collected user input data may be determined to include at least one of (i) an order of the retrieved at least one DRM-protected media element or (ii) an order of the at least one user input.

Optionally, at step 220, upon receiving the at least one user input, the at least one DRM-protected media element may be retrieved (e.g., via application server 115). The at least one DRM-protected media element may be retrieved based on an associated user input. For example, when a user (e.g., user 105) inputs the keystroke “K,” the DRM-protected media element representing the letter “K” may be retrieved (e.g., via application server 115).

In some embodiments, the at least one DRM-protected media element may be retrieved from a cache of generated DRM-protected media elements. As depicted in method 260 of FIG. 2C, at step 265, the at least one DRM-protected media element may be generated (e.g., via application server 115). As discussed herein, the DRM-protected media element may be generated as a single frame-looped video. The DRM-protected media element may be generated to be a representation of a user input. For example, where a user (e.g., user 105) inputs the keystroke “K,” the DRM-protected media element may be generated to represent the letter “K.”

In some embodiments, the at least one DRM-protected media element may be generated based on possible keystrokes (e.g., via application server 115). As discussed herein, the possible keystrokes may be customized based on an alphabet (e.g., alphabets of various languages), numbers (e.g., Arabic numerals, Roman numerals, etc.), symbols (e.g., ampersand, asterisk, percent, exclamation point, en dash, em dash, carrot, parentheses, etc.), etc. For example, the possible keystrokes for a Latin alphabet keyboard may vary from the possible keystrokes for a Cyrillic alphabet keyboard.

In some embodiments, the at least one DRM-protected media element may be generated to associate a given DRM-protected media element with a given user input (e.g., via application server 115). As discussed herein, the association may be based on the DRM-protected media element matching the user input, a representation of the DRM-protected media element, or it may be random. For example, a DRM-protected media element may be generated to include a single frame-looped video of the number “3” to be associated with the keystroke “3.” In another example, a DRM-protected media element may be generated to include a single frame-looped video of the symbol “%” to be associated with the keystroke “3.” As such, when a user (e.g., user 105) enters the keystroke “3,” the DRM-protected media that may be caused to be output (e.g., via GUI 112) may be a single frame-looped video of the symbol “%.” Associating an unrelated or random symbol, number, or letter with the user input value may prevent exposure of the actual keystroke value(s).

In some embodiments, a randomly generated at least one DRM-protected media element may be caused to be output (e.g., via GUI 112) as a first layer under a second layer that includes the real user input. As such, if digital extraction is not occurring, the second layer may be visible (e.g., via GUI 112). If digital extraction is occurring, the second layer may be converted to be transparent such that the first layer becomes visible (e.g., via GUI 112). The layering described herein may be as described in U.S. Provisional Patent Application No. 63/683,063, filed Aug. 14, 2024, which is incorporated by reference herein in its entirety.

At step 270, the generated at least one DRM-protected media element may be cached in a Document Object Model (“DOM”) associated with the media content (e.g., via application server 115). The at least one DRM-protected media element may be cached based on the user input data. For example, a DRM-protected media element representing the letter “F” may be cached with user input data that this DRM-protected media element is associated with the keystroke “F.” In another example, a DRM-protected media element representing the symbol “#” may be cached with user input data that this DRM-protected media element is associated with the keystroke “F.” In some embodiments, the at least one DRM-protected media element may have been cached prior to the user input. For example, the at least one DRM-protected media element may have been generated based on all possible user inputs (e.g., all possible keystrokes, actuations, selections, etc.) and cached (e.g., via data storage 130). In some embodiments, the at least one DRM-protected media element may be retrieved from the Document Object Model (“DOM”). For example, if the user input includes an input based on a known character and an input based on an unknown character, at least one DRM-protected media element may be retrieved from the DOM based on the known character and at least one DRM-protected media element may be generated based on the unknown character. The at least one DRM-protected media element generated based on the unknown character may be cached. In another example, if the user input includes “A,” “A,” “A,” and “A” and there are only two (2) DRM-protected media elements cached for the keystroke “A,” the two cached DRM-protected media elements may be caused to be output (e.g., via GUI 112), and at least two further DRM-protected media elements for “A” may be generated and caused to be output (e.g., via GUI 112).

Returning to FIG. 2A, at step 225, based on the at least one user input, at least one DRM-protected media element may be appended to the DRM-protected input field (e.g., via browser module 111 or application server 115). In some embodiments, the at least one DRM-protected media element may be appended to the DRM-protected input field based on one or both of the at least one user input (e.g., at least one keystroke) or the user input data (e.g., an order of the keystroke(s)). For example, where the user input data includes the keystrokes “A,” “B,” and “C” in that order, the DRM-protected media element representative of the keystroke “A,” then the DRM-protected media element representative of the keystroke “B,” then the DRM-protected media element representative of the keystroke “C” may be appended to the DRM-protected input field.

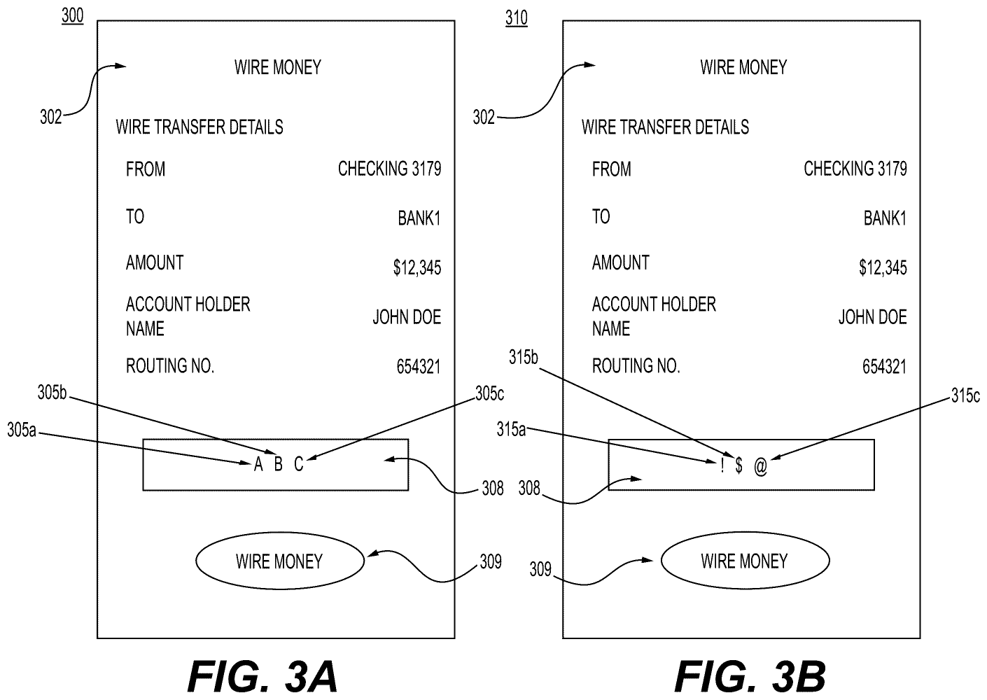

At step 230, the DRM-protected input field with the appended DRM-protected media may be caused to be output (e.g., via GUI 112). FIG. 3A depicts an exemplary output of a GUI (e.g., GUI 112) when digital extraction is not indicated. As depicted in schematic 300 of FIG. 3A, a user (e.g., user 105) may provide at least one user input 305a, 305b, 305c to a DRM-protected input field 308 of a media content 302. Media content 302 may be a webpage associated with a wire transfer that may be initiated once a correct user input is provided via DRM-protected input field 308 and an actuator 309 is actuated. First user input 305a may be the keystroke “A,” second user input 305b may be the keystroke “B,” and third user input 305c may be the keystroke “C.”

FIG. 3B depicts an exemplary output of a GUI (e.g., GUI 112) when digital extraction is indicated. As depicted in schematic 310 of FIG. 3B, when a user (e.g., user 105) provides the at least one user input (e.g., at least one user input 305a, 305b, 305c) to DRM-protected input field 308 (as depicted in FIG. 3A), the at least one user input (e.g., at least one user input 305a, 305b, 305c) may be displayed as at least one appended DRM-protected media 315a, 315b, 315c. For example, where the first user input 305a is the keystroke “A,” the first appended DRM-protected media 315a may be the symbol “!”. Where the second user input 305b is the keystroke “B,” the second appended DRM-protected media 315b may be the symbol “$”. Where the third user input 305c is the keystroke “C,” the third appended DRM-protected media 315c may be the symbol “@”.

Optionally, at step 235, whether the at least one user input matches an expected input value may be determined (e.g., via application server 115). As discussed herein, the expected input value may be the at least one user input or user input data that may be expected for a given DRM-protected input field.

In some embodiments, the retrieved DRM-protected media element may be converted to a text element and compared to the user input to determine whether there is a match to the expected input value. The retrieved DRM-protected media element may be converted based on what the DRM-protected media element may represent. For example, where the DRM-protected media is the letter “P” but is representative of the number “3,” the DRM-protected media may be converted to the text element “3.” The converted text element(s) may be compared to the user input to determine whether there is a match to the expected input value. For example, where the DRM-protected media is converted to the text element “3” and the expected input value is “3,” a match may be determined. In another example, where the DRM-protected media is converted to the text element “3” and the expected input value is “5,” it may be determined there is no match.

In some embodiments, whether the at least one user input matches an expected input value may be determined based on at least one of (i) an order of the retrieved at least one DRM-protected media element or (ii) an order of the at least one user input (e.g., via application server 115). As depicted in method 275 of FIG. 2D, at step 280, at least one of (i) an order of the retrieved at least one DRM-protected media element or (ii) an order of the at least one user input may be determined. The order of the retrieved at least one DRM-protected media element may be the order in which the at least one DRM-protected media element may have been retrieved from the DOM based on the at least one user input. To facilitate determining the order of the retrieved at least one DRM-protected media element, the at least one DRM-protected media element may be converted to text element(s), as discussed above. The order of the at least one user input may be determined from the user input data.

At step 285, it may be determined whether at least one of (i) the order of the retrieved at least one DRM-protected media element or (ii) the order of the at least one user input matches an expected input value. In some embodiments, the order of at least one DRM-protected media element may be analyzed based on the user input each of the at least one DRM-protected media element represents. For example, where the order of the at least one DRM-protected media element is “1” (representing the keystroke “A”) then “2” (representing the keystroke “B”) then “3” (representing the keystroke “C”), the order of the at least one DRM-protected media element may be determined to represent the keystrokes “A” then “B” then “C”. If the expected input value is “A” then “B” then “C”, it may be determined there is a match. If the expected input value is “C” then “B” then “A”, it may be determined there is not a match.

In some embodiments, the order of the at least one user input may be directly compared to the expected input value. For example, if the expected input value is “A” then “3,” a user input of “3” then “A” may be determined not to match. In another example, if the expected input value is “A” then “3,” a user input of “A” then “3” may be determined to match.

At step 290, upon determining at least one of (i) the order of the retrieved at least one DRM-protected media element or (ii) the order of the at least one user input does not match the expected input value, at least one protective measure may be initiated (see discussion of step 240 below for more detail).

At step 240, upon determining the at least one user input does not match an expected input value, one or both of (i) at least one protective measure may be initiated (e.g., via DRM-protection system 126) or (ii) at least one alert may be caused to be output (e.g., via at least one of GUI 112 or GUI 127).

In some embodiments, the at least one protective measure may be initiated (e.g., via DRM-protection system 126) based on receipt of at least one user input (e.g., the second user input), the indication of digital extraction, the at least one alert (e.g., the first alert, the second alert, the third alert, etc.), etc. As discussed herein, the at least one protective measure may include at least one of pausing, locking, canceling, etc. an account (e.g., a financial account) associated with the sensitive information, pausing a current financial transaction, pausing subsequent financial transactions, transmitting the at least one alert (e.g., to GUI 112), etc. For example, where a user (e.g. user 105) is attempting to authorize a wire transfer, the current financial transaction and subsequent financial transactions may be paused upon the determination that at least one of (i) the order of the retrieved at least one DRM-protected media element or (ii) the order of the at least one user input does not match the expected input value. In another example, where a user (e.g. user 105) is attempting to authorize a wire transfer, the current financial transaction and subsequent financial transactions may be paused upon the determination that digital extraction is indicated.

In some embodiments, the at least one alert (e.g., a first alert, a second alert, etc.) may be generated (e.g., via DRM-protection system 126) based on the intended recipient. In some embodiments, the first alert may be generated based on the user (e.g., user 105) being the intended recipient. For example, the first alert may be generated to may be generated to include a natural language message for user 105 (e.g., “Your data may be at risk,” “Your information may be exposed,” etc.). In some embodiments, the second alert may be generated based on the third-party user (e.g., third-party user 120) being the intended recipient. For example, the second alert may be generated to include a natural language message for user 120 (e.g., “User A's data may be compromised,” etc.).

In some embodiments, the at least one alert may be generated (e.g., via DRM-protection system 126) based on the indication of digital extraction. For example, the first alert may be generated in response to receipt of the determination that digital extraction is indicated and transmitted to the user (e.g., to user device 110 associated with user 105). In another example, the second alert may be generated in response to receipt of the determination that digital extraction is indicated and transmitted to the third-party user (e.g., to third-party device 125 associated with third-party user 120).

In some embodiments, the at least one alert may be generated (e.g., via DRM-protection system 126) based on the at least one user input (e.g., a first user input, a second user input, etc.). For example, the at least one alert may be generated based on the determination that at least one of (i) the order of the retrieved at least one DRM-protected media element or (ii) the order of the at least one user input does not match the expected input value (see step 285).

Currently, DRM technologies are not configured to dynamically protect sensitive information as it is being input or while digital extraction may be occurring. In other words, sensitive information entered after a media content loads may not be protected. By applying DRM technologies using the techniques described herein, dynamically entered sensitive information may be protected in ways it historically has not been.

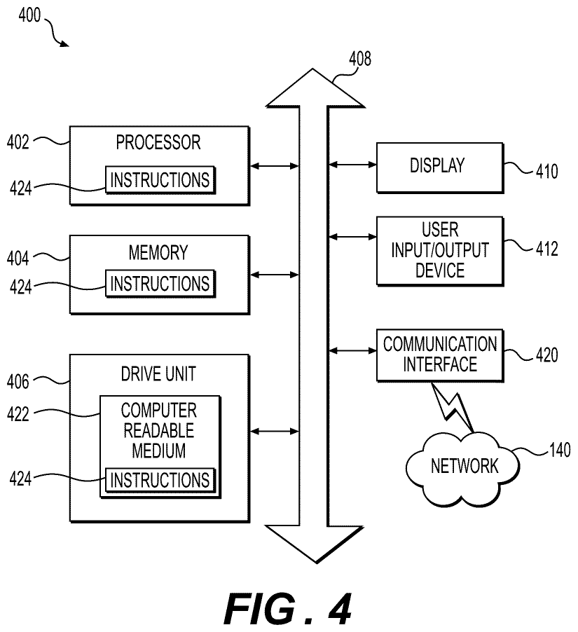

FIG. 4 depicts a simplified functional block diagram of a computer 400 that may be configured as a device for executing the methods disclosed here, according to exemplary embodiments of the present disclosure. For example, the computer 400 may be configured as a system according to exemplary embodiments of this disclosure. In various embodiments, any of the systems herein may be a computer 400 including, for example, a data communication interface 420 for packet data communication. The computer 400 also may include a central processing unit (CPU) 402, in the form of one or more processors, for executing program instructions. The computer 400 may include an internal communication bus 408, and a storage unit 406 (such as ROM, HDD, SDD, etc.) that may store data on a computer readable medium 422, although the computer 400 may receive programming and data via network communications. The computer 400 may also have a memory 404 (such as RAM) storing instructions 424 for executing techniques presented herein, although the instructions 424 may be stored temporarily or permanently within other modules of computer 400 (e.g., processor 402 or computer readable medium 422). The computer 400 also may include input and output ports 412 or a display 410 to connect with input and output devices such as keyboards, mice, touchscreens, monitors, displays, etc. The various system functions may be implemented in a distributed fashion on a number of similar platforms, to distribute the processing load. Alternatively, the systems may be implemented by appropriate programming of one computer hardware platform.

Program aspects of the technology may be thought of as “products” or “articles of manufacture” typically in the form of executable code or associated data that is carried on or embodied in a type of machine-readable medium. “Storage” type media include any or all of the tangible memory of the computers, processors or the like, or associated modules thereof, such as various semiconductor memories, tape drives, disk drives and the like, which may provide non-transitory storage at any time for the software programming. All or portions of the software may at times be communicated through the Internet or various other telecommunication networks. Such communications, for example, may enable loading of the software from one computer or processor into another, for example, from a management server or host computer of the mobile communication network into the computer platform of a server or from a server to the mobile device. Thus, another type of media that may bear the software elements includes optical, electrical and electromagnetic waves, such as used across physical interfaces between local devices, through wired and optical landline networks and over various air-links. The physical elements that carry such waves, such as wired or wireless links, optical links, or the like, also may be considered as media bearing the software. As used herein, unless restricted to non-transitory, tangible “storage” media, terms such as computer or machine “readable medium” refer to any medium that participates in providing instructions to a processor for execution.

It should be appreciated that in the above description of exemplary embodiments of the invention, various features of the invention are sometimes grouped together in a single embodiment, figure, or description thereof for the purpose of streamlining the disclosure and aiding in the understanding of one or more of the various inventive aspects. This method of disclosure, however, is not to be interpreted as reflecting an intention that the claimed invention requires more features than are expressly recited in each claim. Rather, as the following claims reflect, inventive aspects lie in less than all features of a single foregoing disclosed embodiment. Thus, the claims following the Detailed Description are hereby expressly incorporated into this Detailed Description, with each claim standing on its own as a separate embodiment of this invention.

Furthermore, while some embodiments described herein include some but not other features included in other embodiments, combinations of features of different embodiments are meant to be within the scope of the invention, and form different embodiments, as would be understood by those skilled in the art. For example, in the following claims, any of the claimed embodiments can be used in any combination.

Thus, while certain embodiments have been described, those skilled in the art will recognize that other and further modifications may be made thereto without departing from the spirit of the invention, and it is intended to claim all such changes and modifications as falling within the scope of the invention. For example, functionality may be added or deleted from the block diagrams and operations may be interchanged among functional blocks. Steps may be added or deleted to methods described within the scope of the present invention.

The above disclosed subject matter is to be considered illustrative, and not restrictive, and the appended claims are intended to cover all such modifications, enhancements, and other implementations, which fall within the true spirit and scope of the present disclosure. Thus, to the maximum extent allowed by law, the scope of the present disclosure is to be determined by the broadest permissible interpretation of the following claims and their equivalents, and shall not be restricted or limited by the foregoing detailed description. While various implementations of the disclosure have been described, it will be apparent to those of ordinary skill in the art that many more implementations are possible within the scope of the disclosure. Accordingly, the disclosure is not to be restricted except in light of the attached claims and their equivalents.

What is claimed is:

1. A method for generating a digital rights management (“DRM”)-protected input field of a media content, the method comprising:
receiving, via a first graphical user interface (“GUI”), at least one user input associated with a DRM-protected input field, wherein the DRM-protected input field has been caused to be output via the GUI and is substantially hidden from view;
based on the at least one user input, appending at least one DRM-protected media element to the DRM-protected input field via a browser module; and
causing to output, via the first GUI, the DRM-protected input field with the appended DRM-protected media such that the appended DRM-protected media is substantially visible via the first GUI.

2. The method of claim 1, further comprising:
detecting, via an application server, an input element of a HyperText Markup Language (“HTML”) associated with the media content; and
replacing, via the application server, the input element in the HTML with a div element to generate the DRM-protected input field.

3. The method of claim 1, further comprising:
generating the HTML associated with the media content such that the HTML includes the DRM-protected input field; and
causing to output, via the GUI, the DRM-protected input field.

4. The method of claim 1, further comprising:
generating, via the application server, the DRM-protected input field such that the DRM-protected input field is substantially hidden from view using Cascading Style Sheets (“CSS”).

5. The method of claim 1, further comprising:
generating, via the application server, the at least one DRM-protected media element based on possible keystrokes; and
caching, via the application server, the at least one DRM-protected media element in a Document Object Model (“DOM”) associated with the media content.

6. The method of claim 5, further comprising:
upon receiving the at least one user input, retrieving the at least one DRM-protected media element from the DOM via the application server; and
appending, via the browser module, the retrieved at least one DRM-protected media element to the DRM-protected input field.

7. The method of claim 6, further comprising:
determining, via an analysis system, at least one of (i) an order of the retrieved at least one DRM-protected media element or (ii) an order of the at least one user input; and
determining, via the analysis system, whether at least one of (i) the order of the retrieved at least one DRM-protected media element or (ii) the order of the at least one user input matches an expected input value.

8. The method of claim 7, further comprising:
converting, via the application server, each of the retrieved at least one DRM-protected media element to a text element.

9. The method of claim 7, further comprising:
upon determining at least one of (i) the order of the retrieved at least one DRM-protected media element or (ii) the order of the at least one user input does not match the expected input value, initiating at least one protective measure via the analysis system.

10. The method of claim 1, further comprising:
based on the at least one user input, generating a first alert via an analysis system; and
causing to output the first alert via the first GUI.

11. The method of claim 1, further comprising:
based on the at least one user input, generating a second alert via an analysis system; and
causing to output the second alert via a second GUI.

12. A system, the system comprising:
at least one memory storing instructions; and
at least one processor operatively connected to the memory, and configured to execute the instructions to perform operations for generating a DRM-protected input field of a media content, the operations including:
receiving, via a first graphical user interface (“GUI”), at least one user input associated with a DRM-protected input field, wherein the DRM-protected input field has been caused to be output via the GUI and is substantially hidden from view;
based on the at least one user input, appending at least one DRM-protected media element to the DRM-protected input field via a browser module; and
causing to output, via the first GUI, the DRM-protected input field with the appended DRM-protected media such that the appended DRM-protected media is substantially visible via the first GUI.

13. The system of claim 12, the operations further comprising:
detecting, via an application server, an input element of an HTML associated with the media content; and
replacing, via the application server, the input element in the HTML with a div element to generate the DRM-protected input field.

14. The system of claim 12, the operations further comprising further comprising:
generating the HTML associated with the media content such that the HTML includes the DRM-protected input field; and
causing to output, via the GUI, the DRM-protected input field.

15. The system of claim 12, the operations further comprising:
generating, via the application server, the at least one DRM-protected media element based on possible keystrokes; and
caching, via the application server, the at least one DRM-protected media element in a Document Object Model (“DOM”) associated with the media content.

16. The system of claim 15, the operations further comprising:
upon receiving the at least one user input, retrieving the at least one DRM-protected media element from the DOM via the application server; and
appending, via the application server, the retrieved at least one DRM-protected media element to the DRM-protected input field.

17. The system of claim 16, the operations further comprising:
determining, via an analysis system, at least one of (i) an order of the retrieved at least one DRM-protected media element or (ii) an order of the at least one user input; and
determining, via the analysis system, whether at least one of (i) the order of the retrieved at least one DRM-protected media element or (ii) the order of the at least one user input matches an expected input value.

18. The system of claim 17, the operations further comprising:
upon determining at least one of (i) the order of the retrieved at least one DRM-protected media element or (ii) the order of the at least one user input does not match the expected input value, initiating at least one protective measure via the analysis system.

19. The system of claim 12, the operations further comprising:
based on the at least one user input, generating a first alert via an analysis system; and
causing to output the first alert via the first GUI.

20. A method for generating a digital rights management (“DRM”)-protected input field of a media content, the method comprising:
determining, via a browser module, whether digital extraction is indicated;
upon determining digital extraction is indicated, causing to output, via a first graphical user interface (“GUI”), a DRM-protected input field, the DRM-protected input field having been generated via an application server by:
detecting an input element of an HTML associated with the media content, and
replacing the input element in the HTML with a div element to generate the DRM-protected input field,
wherein the DRM-protected input field is substantially hidden from view using Cascading Style Sheets (“CSS”);
receiving, via the first GUI, at least one user input associated with the DRM-protected input field;
based on the at least one user input, appending at least one DRM-protected media element to the DRM-protected input field via the browser module, wherein the at least one DRM-protected media element is retrieved from a cache in a Document Object Model (“DOM”) associated with the media content; and
causing to output, via the first GUI, the DRM-protected input field with the appended DRM-protected media such that the appended DRM-protected media is substantially visible via the first GUI.
